(19) United States
(12) Patent Application Publication
(10) Pub. No.: US 2007/0122000 A1
(43) Pub. Date: May 31, 2007

(54) Detection of stationary objects in video

(75) Inventors: Peter L. Venetianer, McLean, VA (US); Andrew J. Chosak, Arlington, VA (US); Niels Haering, Reston, VA (US); Alan J. Lipton, Herndon, VA (US); Zhong Zhang, Herndon, VA (US); Weihong Yin, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/288,200

(22) Filed: Nov. 29, 2005

(51) Int. Cl. G06K 9/00

(52) U.S. Cl. 382/103

(57) ABSTRACT

Video processing to detect a stationary object in a video includes: performing background change detection on the video; performing motion detection on the video; determining stable pixels in the video based on the background change detection; and combining the stable pixels to identify at least one stationary object in the video.

### FIELD OF THE INVENTION

This invention generally relates to surveillance systems. Specifically, the invention relates to a video surveillance system that can be used, for example, to detect when an object is inserted into or removed from a scene in a video. More specifically, the invention relates to a video surveillance system that may be configured to perform pixel-level processing to detect a stationary object.

### BACKGROUND OF THE INVENTION

Some state-of-the-art intelligent video surveillance (IVS) systems may perform content analysis on frames generated by surveillance cameras. Based on user-defined rules or policies, IVS systems may be able to automatically detect events of interest and potential threats by detecting, tracking and classifying the objects in the scene. For many IVS applications, object detection, object tracking, object classifying, and activity detection and inferencing may achieve the desired performance. In some scenarios, however, object level processing may be very difficult, for example, when attempting to detect and track a partially occluded object. For example, attempting to detect a bag left behind in a busy scene, where the bag may always be partially occluded, may be very difficult, thus preventing object level tracking of the bag.

### SUMMARY OF THE INVENTION

One embodiment of the invention includes a computer-readable medium comprising software for video processing, which when executed by a computer system, cause the computer system to perform operations comprising a method of: performing background change detection on a video; performing motion detection on the video; determining stable pixels in the video based on the background change detection; and combining the stable pixels to identify at least one stationary object in the video.

One embodiment of the invention includes a computer-based system to perform a method for video processing, the method comprising: performing background change detection on a video; performing motion detection on the video; determining stable pixels in the video based on the background change detection; and combining the stable pixels to identify at least one stationary object in the video.

One embodiment of the invention includes a method for video processing comprising: performing background change detection on a video; performing motion detection on the video; determining stable pixels in the video based on the background change detection; and combining the stable pixels to identify at least one stationary object in the video.

One embodiment of the invention includes an apparatus to perform a video processing method, the method comprising: performing background change detection on a video; performing motion detection on the video; determining stable pixels in the video based on the background change detection; and combining the stable pixels to identify at least one stationary object in the video.

### BRIEF DESCRIPTION OF THE DRAWINGS

The foregoing and other features of various embodiments of the invention will be apparent from the following, more particular description of such embodiments of the invention, as illustrated in the accompanying drawings, wherein like reference numbers generally indicate identical, functionally similar, and/or structurally similar elements. The left-most digit in the corresponding reference number indicates the drawing in which an element first appears.

FIG. 1 illustrates a flow diagram for video processing according to an exemplary embodiment of the invention.

FIGS. 2A-2D illustrate the temporal behavior of a pixel in various scenarios.

FIG. 3 illustrates a flow diagram for stationary object detection according to an exemplary embodiment of the invention.

FIGS. 4A and 4B illustrate monitoring the temporal behavior of a pixel and classifying the stability of the pixel.

FIG. 5 illustrates a dual stability threshold.

FIG. 6 illustrates a flow diagram for stationary object detection according to another exemplary embodiment of the invention.

FIG. 7 illustrates an IVS system according to an exemplary embodiment of the invention.

### DEFINITIONS

In describing the invention, the following definitions are applicable throughout (including above).

“Video” may refer to motion pictures represented in analog and/or digital form. Examples of video may include: television; a movie; an image sequence from a camera or other observer; an image sequence from a live feed; a computer-generated image sequence; an image sequence from a computer graphics engine; an image sequences from a storage device, such as a computer-readable medium, a digital video disk (DVD), or a high-definition disk (HDD); an image sequence from an IEEE 1394-based interface; an image sequence from a video digitizer; or an image sequence from a network.

A “video sequence” refers to some or all of a video.

A “video camera” may refer to an apparatus for visual recording. Examples of a video camera may include one or more of the following: a video camera; a digital video camera; a color camera; a monochrome camera; a camera; a camcorder; a PC camera; a webcam; an infrared (IR) video camera; a low-light video camera; a thermal video camera; a closed-circuit television (CCTV) camera; a pan, tilt, zoom (PTZ) camera; and a video sensing device. A video camera may be positioned to perform surveillance of an area of interest.

“Video processing” may refer to any manipulation and/or analysis of video, including, for example, compression, editing, surveillance, and/or verification.

A “frame” may refer to a particular image or other discrete unit within a video.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor or multiple processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a personal digital assistant (PDA); a portable telephone; application-specific hardware to emulate a computer and/or software, such as, for example, a digital signal processor (DSP), a field-programmable gate array (FPGA), a chip, chips, or a chip set; a distributed computer system for processing information via computer systems linked by a network; two or more computer systems connected together via a network for transmitting or receiving information between the computer systems; and one or more apparatus and/or one or more systems that may accept data, may process data in accordance with one or more stored software programs, may generate results, and typically may include input, output, storage, arithmetic, logic, and control units.

“Software” may refer to prescribed rules to operate a computer. Examples of software may include software; code segments; instructions; computer programs; and programmed logic.

A “computer system” may refer to a system having a computer, where the computer may include a computer-readable medium embodying software to operate the computer.

A “network” may refer to a number of computers and associated devices that may be connected by communication facilities. A network may involve permanent connections such as cables or temporary connections such as those made through telephone or other communication links. Examples of a network may include: an internet, such as the Internet; an intranet; a local area network (LAN); a wide area network (WAN); and a combination of networks, such as an internet and an intranet.

### DETAILED DESCRIPTION OF THE EMBODIMENTS

Exemplary embodiments of the invention are discussed in detail below. While specific exemplary embodiments are discussed, it should be understood that this is done for illustration purposes only. In describing and illustrating the exemplary embodiments, specific terminology is employed for the sake of clarity. However, the invention is not intended to be limited to the specific terminology so selected. A person skilled in the relevant art will recognize that other components and configurations may be used without parting from the spirit and scope of the invention. It is to be understood that each specific element includes all technical equivalents that operate in a similar manner to accomplish a similar purpose. Each reference cited herein is incorporated by reference. The examples and embodiments described herein are non-limiting examples.

Detecting a stationary object, more specifically, detecting the insertion and/or removal of an object of interest, has several IVS applications. For example, detecting the insertion of an object may be used to detect: when a car is parked; when a car is stopped for a prescribed amount of time; when an item, such as a bag or other suspicious object, is left in a location, such as, for example, in an airport terminal or next to an important building. For example, detecting the removal of an object may be used to detect: when an item is stolen, such as, for example, when an artifact is taken from a museum; when a parked car is moved to a new location; when the location of an item is changed, such as, for example, when a chair is moved from one location to another. As an example, detecting the insertion and/or removal of an object may be used to detect vandalism: placing graffiti on a wall; removing a street sign; slashing a seat on a public transportation vehicle; breaking a window in a car in a parking lot.

Detecting an occluded stationary object, where the occlusion varies over time, may be difficult in an object-based approach to intelligent video surveillance. In such an object-based approach, the stationary object may be merged with other objects and not separately detected. For example, if a bag is left behind in a crowded location, where people continuously walk in front of or behind the bag, the bag may not be detected by the object-based intelligent video surveillance system as a separate, standalone object. As another example, if a person puts a bag down and stays near the bag, the bag may not be detected as a separate object using the object-based approach, and the whole person in combination with the bag object further may not be detected as stationary using the object-based approach. In such exemplary cases, a pixel-based approach may complement the object-based approach and may allow the detection of the stationary object, even if it is part of a larger object, like the bag in the above example.

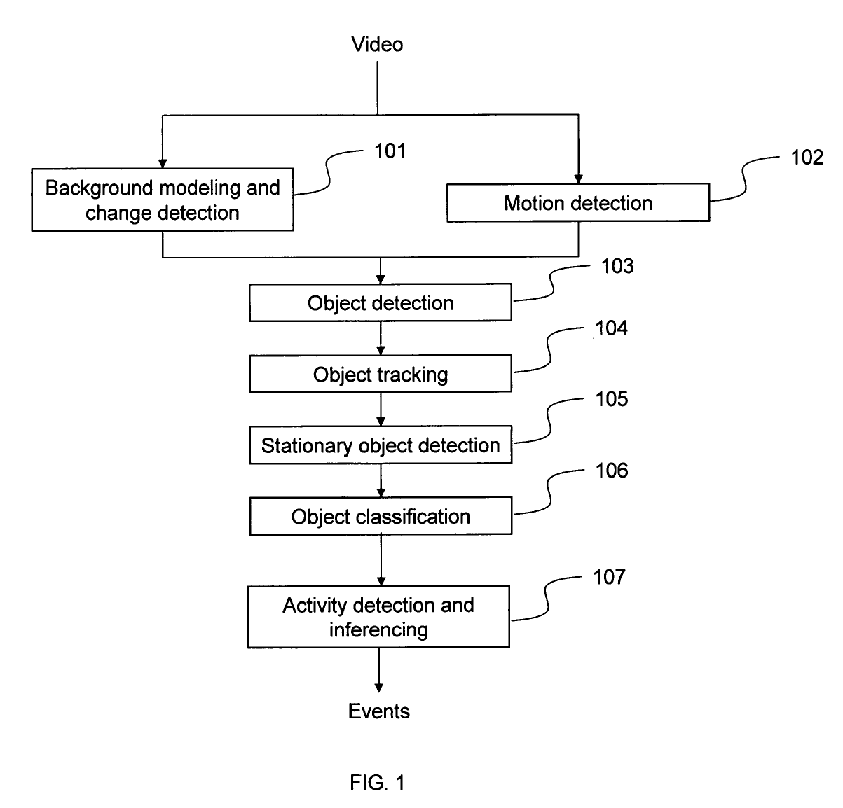

FIG. 1 illustrates a flow diagram for video processing according to an exemplary embodiment of the invention. In block 101, background modeling and change detection may be performed. Background modeling and change detection may model the stable state of each pixel, and pixels differing from the background model are labeled foreground.

In block 102, motion detection may be performed. Motion detection may detect pixels that change between frames, for example, using three-frame differencing and may label the pixels as motion pixels.

In block 103, object detection may be performed. For object detection, the foreground pixels from block 101 and the motion pixels from block 102 may be grouped spatially to detect objects.

In block 104, object tracking may be performed.

In block 105, stationary object detection may be performed. The stationary target detection may detect whether a target is stationary or not and may also detect whether the stationary target was inserted or removed. Block 105 may perform stationary object detection using a pixel-based approach and may place the stationary object in the background model of block 101.

In block 106, object classification may be performed. The object classification in block 106 may attempt to classify any stationary objects detected in block 105. If the detected stationary object from block 105 has a large overlap with a tracked object from block 104, the detected stationary object may inherit the classification of the tracked object.

In block 107, activity detection and inferencing may be preformed to obtain events. Activity detection and inferencing may correspond to the user's needs. For example, if a user wants to know if a vehicle was parked in a certain area for at least 5 minutes, the activity detection and inferencing may determine if any of the stationary objects detected in block 105 meet this criterion.

Blocks 101-104, 106, and 107 may be implemented as discussed in Lipton et al., “Video Surveillance System Employing Video Primitives,” U.S. patent application Ser. No. 09/987,707.

In one embodiment, block 105 in FIG. 1 may be performed anywhere after blocks 101 and 102 and before block 107. With block 106 occurring after block 105, the object classification in block 106 may attempt to classify any stationary objects detected in block 105.

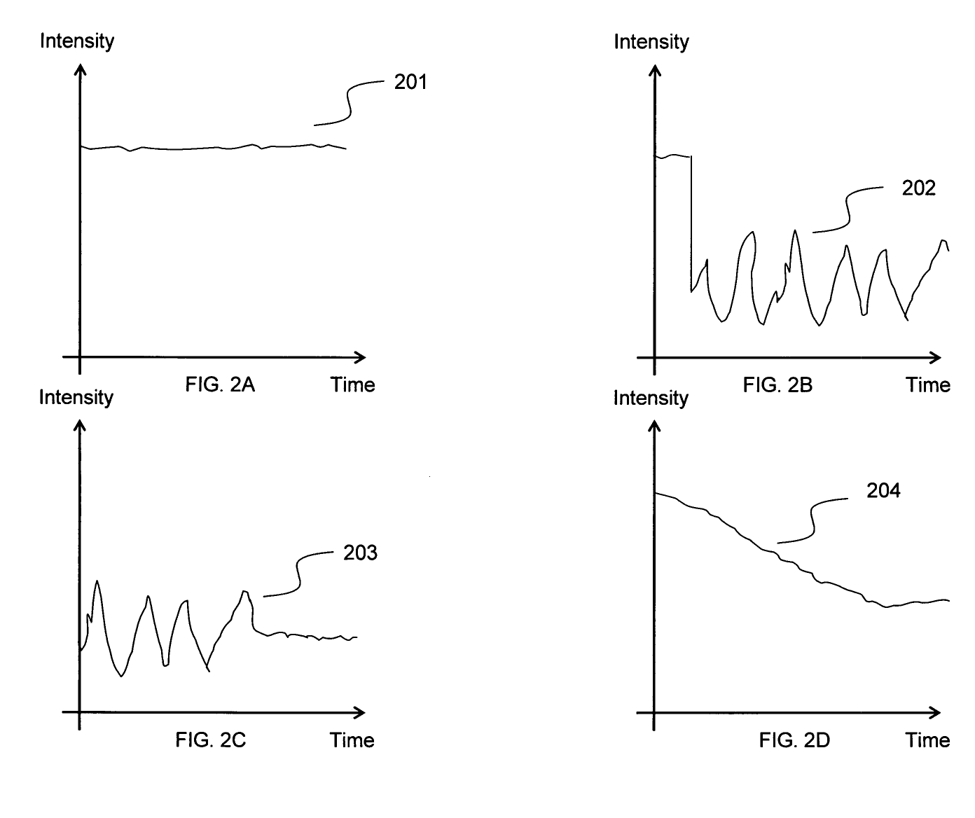

FIGS. 2A-2D illustrate the temporal behavior of a pixel in various scenarios. In each figure, a plot of the intensity of the pixel versus time is provided. In FIG. 2A, an intensity 201 for a stable background pixel may exhibit very small variability due to image noise. In FIG. 2B, an intensity 202 for an object moving across a pixel may exhibit a value centered around the color of the moving object, but with large variations. In FIG. 2C, an intensity 203 for an object moving across a pixel and stopping at the pixel may exhibit a new background intensity value after the movement has stopped. In FIG. 2D, an intensity 204 for a lighting change of a pixel (e.g., lighting change due to the time of the day) may exhibit a slow change over time.

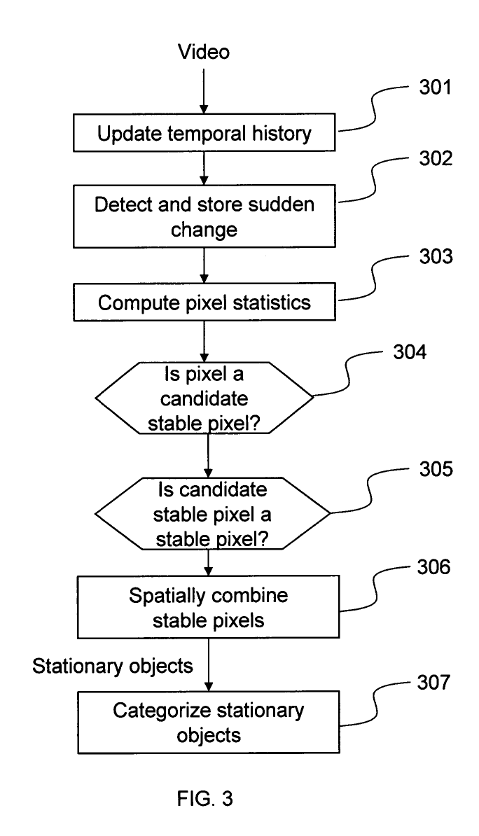

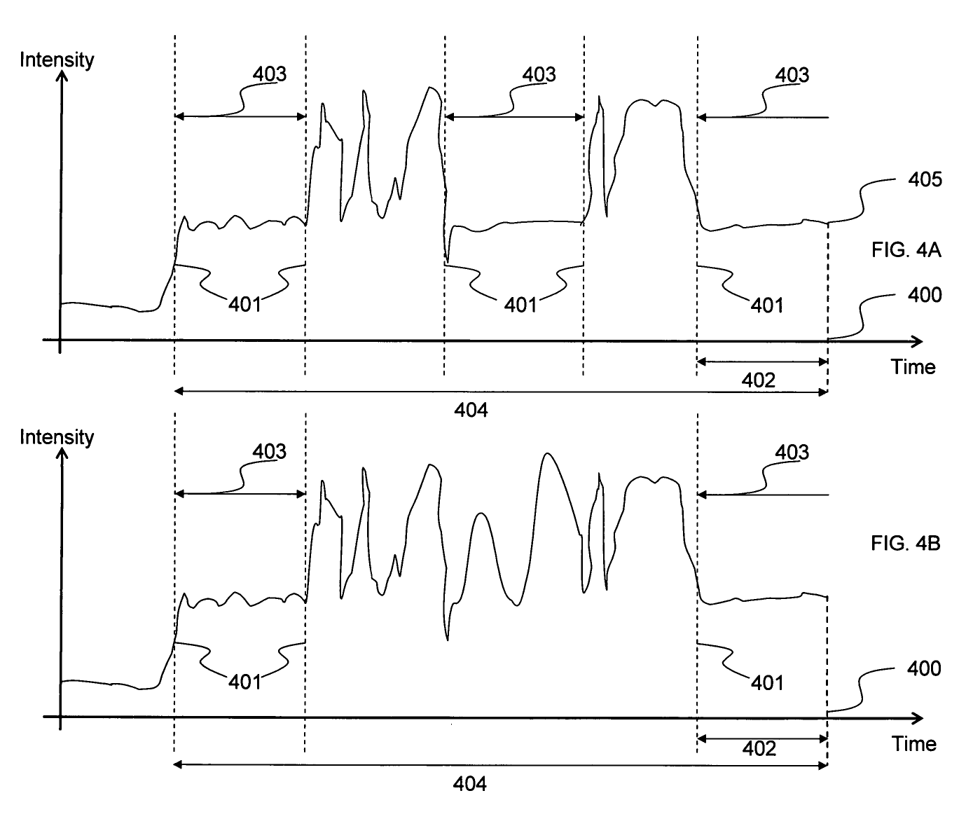

FIG. 3 illustrates a flow diagram for stationary object detection in block 105 according to an exemplary embodiment of the invention. The flow diagram of FIG. 3 may be for a current time sample, and may be repeated for a next time sample. The current time sample may or may not be related to the frame rate of the video. FIG. 3 is discussed in relation to FIGS. 4A and 4B. FIGS. 4A and 4B illustrate an exemplary monitoring of the temporal behavior of a pixel and classifying the stability of the pixel. In each figure, a plot of the intensity of a pixel versus time is provided. FIGS. 4A and 4B illustrate the plots for two separate exemplary pixels.

In block 301, the temporal history of the intensity of all pixels may be updated for the current time sample. The temporal history is maintained for previous time samples and updated for the current time sample. For example, as illustrated in FIGS. 4A and 4B, the temporal history of the intensity of the pixels may be updated for the current time sample 400.

In block 302, if a sudden, sharp change in the pixel intensity is detected for the current time sample, the current time sample may be stored as a sudden, sharp change. A sudden, sharp change may be detected as a large difference between a pixel's current value and the pixel's values over a time window of previous values. The detected sudden, sharp change may represent the start or end of an occlusion. In FIGS. 4A and 4B, the times of sudden, sharp changes in the pixel intensity are identified with reference numerals 401.

In block 303, statistics for each pixel may be computed for the current time sample. For example, statistics, such as the mean and variance of the intensity of each pixel, may be computed. Examples of other statistics that may be computed include higher order statistics. The time window used to determine the statistics for a pixel may be from the current time sample to the latest sudden, sharp change detected for the pixel in block 302. In FIGS. 4A and 4B, the time windows for determining statistics are from the current time sample 400 to the latest sudden, sharp change 401 and are identified with reference numerals 402. For the time samples that occurred prior to time window 402, statistics may be computed based on the time window from the time sample being considered to the previous sudden, sharp change 401.

In block 304, each pixel may be analyzed to determine whether the pixel is a candidate stable pixel for the current time sample. A pixel may be determined to be a candidate stable pixel based on the statistics from block 303. For example, a pixel may be determined to be a candidate stable pixel if the variance of the intensity of the pixel is low. As another example, a pixel may be determined to be a candidate stable pixel if the difference between its minimum and maximum values is smaller than a predefined threshold. If a pixel is determined to be a candidate stable pixel, the pixel may be marked as a candidate stable pixel. On the other hand, if a pixel is determined not to be a candidate stable pixel, the pixel may be marked as not a candidate stable pixel. In FIGS. 4A and 4B, the time samples at which each pixel is determined to be a candidate stable pixel may be those time samples within the time windows identified with reference numerals 403, and the time samples at which each pixel is determined not to be a candidate stable pixel may be those time samples outside the time windows identified with reference numerals 403. In FIGS. 4A and 4B, each pixel for the current time sample 400 may be determined to be a candidate stable pixel.

In block 305, each candidate stable pixel from block 304 may be analyzed to determine whether the candidate stable pixel is a stable pixel for the current time sample. If a candidate stable pixel is determined to be a candidate stable pixel for a particular amount of time (known as stability) greater than or equal to a temporal stability threshold across a time window, the candidate stable pixel may be determined to be a stable pixel for the current time sample. On the other hand, if a candidate stable pixel is determined not to be a candidate stable pixel for a particular amount of time greater than or equal to a temporal stability threshold across a time window, the candidate stable pixel may be determined not to be a stable pixel for the current time sample. The temporal stability threshold and the length of the time window may depend on the application environment. For example, if the goal is to detect if a bag was left somewhere for more than approximately 30 seconds, the time window may be set to 45 seconds, and the temporal stability threshold may be set to 50%. Hence, for a pixel of the bag to be identified as a stable pixel, the pixel may need to be stable (e.g., visible) for at least 22.5 seconds during the time window.

In FIGS. 4A and 4B, the temporal stability threshold may be 50%, and the time window may be time window 404. If the pixel is determined to be a candidate stable pixel for at least 50% of the time in the time window 404, the pixel may be determined to be a stable pixel for the current time sample 400. In FIG. 4A, the pixel may be determined to be a candidate stable pixel for approximately 60% of the time in the time window 404 (i.e., the length of the three time windows 403 compared to the length of the time window 404), which is greater than the temporal stability threshold of 50%, and the pixel may be determined to be a stable pixel 405 for the current time sample 400. On the other hand, in FIG. 4B, the pixel may be determined to be a candidate stable pixel for approximately 40% of the time in the time window 404 (i.e., the length of the two time windows 403 compared to the length of the time window 404), which is less than the temporal stability threshold of 50%, and the pixel may be determined not to be a stable pixel for the current time sample 400.

In block 306, the stable pixels identified in block 305 may be combined spatially to create one or more stationary objects. Various algorithms to combine pixels into objects (or blobs) are known from the art.

In block 307, each detected stationary object from block 306 may be categorized as an inserted stationary object or a removed stationary object. To determine the categorization, the homogeneity (e.g., sharpness of edges, strength of edges, or number of edges) or texturedness of the detected stationary object for the current frame may be compared to the homogeneity or texturedness in the background model at the same location of detected stationary object. As an example, if the detected stationary object for the current frame is less homogeneous, has sharper edges, has stronger edges, has more edges, or has a stronger texture than the same location in the background model, the detected stationary object may be classified as an inserted stationary object; otherwise, the detected stationary object may be classified as a removed stationary object. Referring to FIG. 4A, the stationary object may be categorized as an inserted stationary object if the stationary object is less homogeneous at the current time sample 400 than the corresponding area of the stationary object in the background model; otherwise, the stationary object may be categorized as a removed stationary object. The background model may be previously last updated before the first sudden, sharp change 401 (i.e., the time to the left of time window 404). The background model may be the same before the first sudden, sharp change 401 and the current time sample 400, because in the time period between 401 and 400, the area of the stationary objects may be treated as foreground, thus not affecting the background model.

In an exemplary embodiment, the flow diagram of FIG. 3 may be performed on spatially sub-sampled images of the video to reduce memory and/or computational requirements.

In an exemplary embodiment, the flow diagram of FIG. 3 may be performed on temporally sub-sampled images of the video to reduce memory and/or computational requirements. For example, the flow diagram of FIG. 3 may be performed for a lower frame rate, which may affect the temporal history of the pixels.

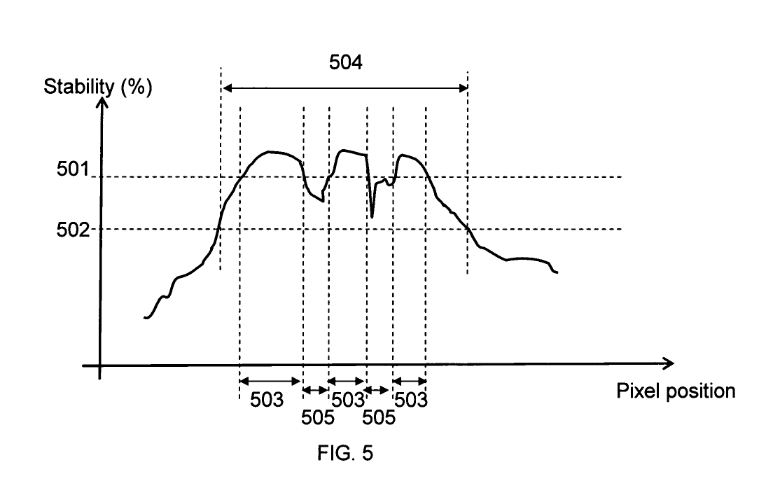

In an exemplary embodiment, the spatial combination in block 306 may include a dual temporal stability threshold. If a sufficient number of stable pixels exist to warrant the detection of a stationary object, other nearby pixels may be analyzed to determine if some of them would have been classified as stable pixels in block 305 with a slightly lower temporal stability threshold. Such pixels may be part of the same stationary object, but may be occluded more than the detected stable pixels. FIG. 5 illustrates a dual stability threshold. In FIG. 5, a plot is shown for the stability determined in block 305 across a one-dimensional cross-section of an image for a current time sample. The plotted stability value may represent the percent amount of time each pixel is marked as a candidate stable pixel from the determination in block 305. Pixel values above the high threshold 501 may represent pixels determined to be stable pixels in block 305. The reference numerals 503 refer to the pixels identified as stable pixels with the high threshold 501. For example, referring to FIGS. 4A and 4B, the high threshold 501 may be 50%, and only the pixel in FIG. 4A may be determined to be a stable pixel in block 305.

Referring back to FIG. 5, combining just stable pixels 503 to form a stationary object may leave gaps 505 in the stationary object. Adding pixels with values above the lower threshold 502 may fill in the gaps 505 with pixels that may correspond to the same real object which occupies pixels across area 504. The remaining pixels in the cross-section are not part of the stationary object. For example, referring back to FIGS. 4A and 4B, if the low threshold 502 is 35%, the pixels for the current time sample 400 in both FIGS. 4A and 4B may be determined to be stable pixels. With a dual temporal stability threshold, the high threshold may permit only stationary objects with high confidence to be detected (i.e., objects for which some part may be visible), while the lower threshold may permit the detection of the more occluded portions of the stationary objects as well.

In an exemplary embodiment, if a stationary object is detected in block 105 in FIG. 1, the stationary object may be made part of the background in block 101. Modifying the background model may prevent the stationary object from being repeatedly detected. To accomplish this, the pixel statistics of each pixel in the background model corresponding to the detected stationary object may be modified to represent the new stationary object. Referring to FIG. 4A, the pixel in the background model corresponding to this pixel may have a mean around the value to the left of the first sudden change 401, but when the detected stationary object 405 is added to the background model, the pixel statistics of this pixel in the background model may be replaced with the statistics collected over the time window 403. Once the background in block 101 is modified, subsequent passes through the flow diagram of FIG. 1 may mark the pixels corresponding to the stationary object as unchanged.

In an exemplary embodiment, block 106 may include classifying an object. Although the invention may detect the entire stationary object, not all of the stationary object may be visible in the current frame of the detection, which may make reliable classification in block 106 difficult. If any of the tracked objects from block 104 has a large overlap with the stationary object from block 105, the tracked object may be determined to be the same as the stationary object, and the stationary object may inherit the classification (e.g., human, vehicle, bag, or luggage) of the tracked object. Overlap may be measured by computing the percentage of the pixels overlapping between the tracked object and the stationary object. If there is insufficient overlap, a new object is created in block 106 with no classification or a very low classification confidence.

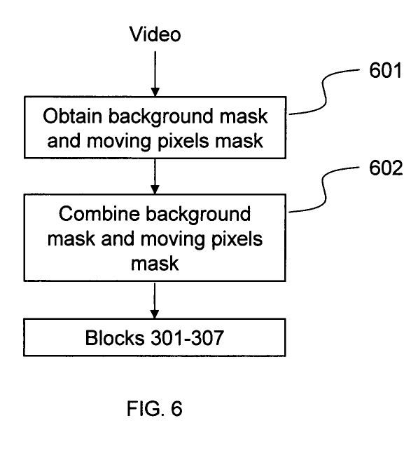

FIG. 6 illustrates a flow diagram for stationary object detection according to another exemplary embodiment of the invention. In FIG. 6, blocks 601 and 602 may be added to those of FIG. 3, such that the flow proceeds from block 602 to block 301. With this embodiment, the non-moving foreground pixels may be employed to speed up the computation. Instead of performing blocks 301-307 on every pixel of the image as in FIG. 3, the procedure may be applied only to the non-moving foreground pixels. However, the output of block 602 may serve as the input to block 301, and all the subsequent blocks of FIG. 3 may be performed as discussed above for FIG. 3, except that there are fewer pixels to process, thereby increasing the computational speed and decreasing the memory usage of the procedure.

In block 601, masks from blocks 101 and 102 may be obtained. In block 101, the background modeling and change detection may detect all pixels that are different from the background and generate a foreground mask. In block 102, the motion detection (for example, three-frame differencing) may detect moving pixels and generate a moving pixels mask, as well as its complementary non-moving pixels mask.

In block 602, the foreground mask and the non-moving pixels mask may be combined to detect the non-moving foreground pixels. For example, the foreground mask and the non-moving pixels mask may be combined using a Boolean AND operation on the pixels of the two masks resulting in a mask having non-moving foreground pixels. As another example, the two masks may be combined after applying morphological operations to them.

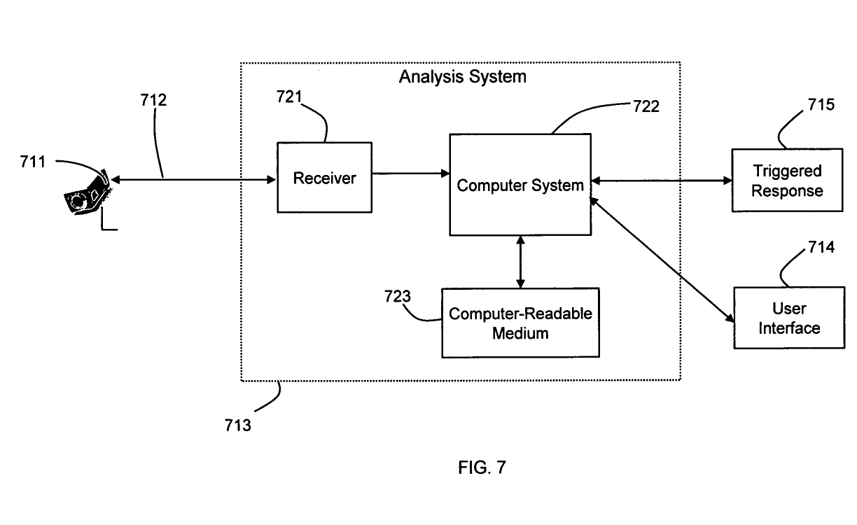

FIG. 7 illustrates an IVS system according to an exemplary embodiment of the invention. The IVS system may include a video camera 711, a communication medium 712, an analysis system 713, a user interface 714, and a triggered response 715. The video camera 711 may be trained on a video monitored area and may generate output signals. In an exemplary embodiment, the video camera 711 may be positioned to perform surveillance of an area of interest.

In an exemplary embodiment, the video camera 711 may be equipped to be remotely moved, adjusted, and/or controlled. With such video cameras, the communication medium 712 between the video camera 711 and the analysis system 713 may be bi-directional (shown), and the analysis system 713 may direct the movement, adjustment, and/or control of the video camera 711.

In an exemplary embodiment, the video camera 711 may include multiple video cameras monitoring the same video monitored area.

In an exemplary embodiment, the video camera 711 may include multiple video cameras monitoring multiple video monitored areas.

The communication medium 712 may transmit the output of the video camera 711 to the analysis system 713. The communication medium 712 may be, for example: a cable; a wireless connection; a network (e.g., a number of computer systems and associated devices connected by communication facilities; permanent connections (e.g., one or more cables); temporary connections (e.g., those made through telephone, wireless, or other communication links); an internet, such as the Internet; an intranet; a local area network (LAN); a wide area network (WAN); a combination of networks, such as an internet and an intranet); a direct connection; an indirect connection). If communication over the communication medium 712 requires modulation, coding, compression, or other communication-related signal processing, the ability to perform such signal processing may be provided as part of the video camera 711 and/or separately coupled to the video camera 711 (not shown).

The analysis system 713 may receive the output signals from the video camera 711 via the communication medium 712. The analysis system 713 may perform analysis tasks, including necessary processing according to the invention. The analysis system 713 may include a receiver 721, a computer system 722, and a computer-readable medium 723.

The receiver 721 may receive the output signals of the video camera 711 from the communication medium 712. If the output signals of the video camera 711 have been modulated, coded, compressed, or otherwise communication-related signal processed, the receiver 721 may be able to perform demodulation, decoding, decompression or other communication-related signal processing to obtain the output signals from the video camera 711, or variations thereof due to any signal processing. Furthermore, if the signals received from the communication medium 712 are in analog form, the receiver 721 may be able to convert the analog signals into digital signals suitable for processing by the computer system 722. The receiver 721 may be implemented as a separate block (shown) and/or integrated into the computer system 722. Also, if it is unnecessary to perform any signal processing prior to sending the signals via the communication medium 712 to the computer system 722, the receiver 721 may be omitted.

The computer system 722 may be coupled to the receiver 721, the computer-readable medium 723, the user interface 714, and the triggered response 715. The computer system 722 may perform analysis tasks, including necessary processing according to the invention.

The computer-readable medium 723 may include all necessary memory resources required by the computer system 722 for the invention and may also include one or more recording devices for storing signals received from the communication medium 712 and/or other sources. The computer-readable medium 723 may be external to the computer system 722 (shown) and/or internal to the computer system 722.

The user interface 714 may provide input to and may receive output from the analysis system 713. The user interface 714 may include, for example, one or more of the following: a monitor; a mouse; a keyboard; a keypad; a touch screen; a printer; speakers and/or one or more other input and/or output devices. The user interface 714, or a portion thereof, may be wirelessly coupled to the analysis system 713. Using user interface 714, a user may provide inputs to the analysis system 713, including those needed to initialize the analysis system 713, provide input to analysis system 713, and receive output from the analysis system 713.

The triggered response 715 may include one or more responses triggered by the analysis system. The triggered response 715, or a portion thereof, may be wirelessly coupled to the analysis system 713. Examples of the triggered response 715 include: initiating an alarm (e.g., audio, visual, and/or mechanical); sending a wireless signal; controlling an audible alarm system (e.g., to notify the target, security personnel and/or law enforcement personnel); controlling a silent alarm system (e.g., to notify security personnel and/or law enforcement personnel); accessing an alerting device or system (e.g., pager, telephone, e-mail, and/or a personal digital assistant (PDA)); sending an alert (e.g., containing imagery of the violator, time, location, etc.) to a guard or other interested party; logging alert data to a database; taking a snapshot using the video camera 711 or another camera; culling a snapshot from the video obtained by the video camera 711; recording video with a video recording device (e.g., an analog or digital video recorder); controlling a PTZ camera to zoom in to the target; controlling a PTZ camera to automatically track the target; performing recognition of the target using, for example, biometric technologies or manual inspection; closing one or more doors to physically prevent a target from reaching an intended target and/or preventing the target from escaping; controlling an access control system to automatically lock, unlock, open, and/or close portals in response to an event; or other responses.

In an exemplary embodiment, the analysis system 713 may be part of the video camera 711. For this embodiment, the communication medium 712 and the receiver 721 may be omitted. The computer system 722 may be implemented with application-specific hardware, such as a DSP, a FPGA, a chip, chips, or a chip set to perform the invention. The user interface 714 may be part of the video camera 711 and/or coupled to the video camera 711. As an option, the user interface 714 may be coupled to the computer system 722 during installation or manufacture, removed thereafter, and not used during use of the video camera 711. The triggered response 715 may be part of the video camera 711 and/or coupled to the video camera 711.

In an exemplary embodiment, the analysis system 713 may be part of an apparatus, such as the video camera 711 as discussed in the previous paragraph, or a different apparatus, such as a digital video recorder or a router. For this embodiment, the communication medium 712 and the receiver 721 may be omitted. The computer system 722 may be implemented with application-specific hardware, such as a DSP, a FPGA, a chip, chips, or a chip set to perform the invention. The user interface 714 may be part of the apparatus and/or coupled to the apparatus. As an option, the user interface 714 may be coupled to the computer system 722 during installation or manufacture, removed thereafter, and not used during use of the apparatus. The triggered response 715 may be part of the apparatus and/or coupled to the apparatus.

The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. A computer-readable medium comprising software for video processing, which when executed by a computer system, cause the computer system to perform operations comprising a method of:
performing background change detection on a video;
performing motion detection on the video;
determining stable pixels in the video based on the background change detection;
combining the stable pixels to identify at least one stationary object in the video.

2. A computer-readable medium as in claim 1, wherein determining stable pixels comprises:
updating temporal histories of intensities of pixels in the video based on the background change detection;
detecting changes in the temporal history of pixel intensity to obtain detected changes;
determining pixel statistics for pixels in the video based on the detected changes;
identifying pixels as candidate stable pixels based on the pixel statistics; and
identifying candidate stable pixels as stable pixels based on the temporal histories.

3. A computer-readable medium as in claim 1, wherein the method is performed on spatially sub-sampled images of the video.

4. A computer-readable medium as in claim 1, wherein the method is performed on temporally sub-sampled images of the video.

5. A computer-readable medium as in claim 1, wherein combining the stable pixels is based on a dual stability threshold.

6. A computer-readable medium as in claim 1, the method further comprising categorizing the stationary object as an inserted stationary object or a removed stationary object.

7. A computer-readable medium as in claim 1, wherein the stationary object is included in the background of the video.

8. A computer-readable medium as in claim 1, the method further comprising detecting activity based on the stationary object.

9. A computer-readable medium as in claim 1, the method further comprising:
detecting an object based on the background change detection and the motion detection to obtain a detected object;
tracking the detected object to obtain a tracked object; and
classifying the object to obtain a classified object.

10. A computer-readable medium as in claim 9, wherein if the tracked object overlaps the stationary object, the stationary object inherits the classification of the tracked object.

11. A computer-readable medium as in claim 1, wherein the background change detection generates a foreground mask, wherein the motion detection generates a non-moving pixels mask, and wherein determining stable pixels comprises:
combining the foreground mask and the non-moving pixels mask to obtain a mask having non-moving foreground pixels, wherein the stable pixels are determined based on the mask having non-moving foreground pixels.

12. A computer-readable medium as in claim 11, wherein the foreground mask and the non-moving pixels mask are combined based on a Boolean AND operation.

13. A computer system to perform operations in accordance with the software of the computer-readable medium of claim 1.

14. An apparatus to perform a video processing method, the method comprising:
performing background change detection on a video;
performing motion detection on the video;
determining stable pixels in the video based on the background change detection;
combining the stable pixels to identify at least one stationary object in the video.

15. An apparatus as in claim 14, wherein determining stable pixels comprises:
updating temporal histories of intensities of pixels in the video based on the background change detection;
detecting changes in the temporal history of pixel intensity to obtain detected changes;
determining pixel statistics for pixels in the video based on the detected changes;
identifying pixels as candidate stable pixels based on the pixel statistics; and
identifying candidate stable pixels as stable pixels based on the temporal histories.

16. An apparatus as in claim 14, wherein the method is performed on spatially sub-sampled images of the video.

17. An apparatus as in claim 14, wherein the method is performed on temporally sub-sampled images of the video.

18. An apparatus as in claim 14, wherein combining the stable pixels is based on a dual stability threshold.

19. An apparatus as in claim 14, the method further comprising categorizing the stationary object as an inserted stationary object or a removed stationary object.

20. An apparatus as in claim 14, wherein the stationary object is included in the background of the video.

21. An apparatus as in claim 14, the method further comprising:
detecting activity based on the stationary object.

22. An apparatus as in claim 14, the method further comprising:
detecting an object based on the background change detection and the motion detection to obtain a detected object;
tracking the detected object to obtain a tracked object; and
classifying the object to obtain a classified object.

23. An apparatus as in claim 22, wherein if the tracked object overlaps the stationary object, the stationary object inherits the classification of the tracked object.

24. An apparatus as in claim 14, wherein the background change detection generates a foreground mask, wherein the motion detection generates a non-moving pixels mask, and wherein determining stable pixels comprises:
combining the foreground mask and the non-moving pixels mask to obtain a mask having non-moving foreground pixels, wherein the stable pixels are determined based on the mask having non-moving foreground pixels.

25. An apparatus as in claim 24, wherein the foreground mask and the non-moving pixels mask are combined based on a Boolean AND operation.

26. An apparatus as in claim 14, wherein the apparatus comprises application-specific hardware to perform the video processing method.

27. A video camera comprising the apparatus of claim 14.

28. A digital video recorder comprising the apparatus of claim 14.

29. A router comprising the apparatus of claim 14.
